(19) United States
(12) Patent Application Publication
(10) Pub. No.: US 2021/0125083 A1
(43) Pub. Date: Apr. 29, 2021

(54) EDGE DEVICES, SYSTEMS AND METHODS FOR PROCESSING EXTREME DATA

(71) Applicant: FACET LABS, LLC, LOS GATOS, CA (US)

(72) Inventors: STUART OGAWA, LOS GATOS, CA (US); LINDSAY SPARKS, SEATTLE, WA (US); KOICHI NISHIMURA, SAN JOSE, CA (US); WILFRED P. SO, MISSISSAUGA (CA)

(21) Appl. No.: 16/494,541

(22) PCT Filed: Mar. 15, 2018
(86) PCT No.: PCT/US2018/022616

§ 371 Date: Sep. 16, 2019

Related U.S. Application Data
(60) Provisional application No. 62/472,349, filed on Mar. 16, 2017.
(60) Provisional application No. 62/483,290, filed on Apr. 7, 2017.
(60) Provisional application No. 62/528,014, filed on Jun. 30, 2017.
(60) Provisional application No. 62/540,499, filed on Aug. 2, 2017.

(51) Int. Cl. G06N 5/04; G06F 9/50; G06N 20/00

(52) U.S. Cl. CPC G06N 5/04; G06N 20/00; G06F 9/5083

(57) ABSTRACT

Systems, devices and methods are provided that can make distributed and autonomous decision science based recommendations, decisions, and actions that increasingly become smarter and faster over time. The system includes intelligent computing devices, networks, electronic devices and other intelligent components or devices, including intelligent transceivers, receivers, and buses. Each of these intelligent devices can optionally have the ability to transmit and receive new data or decision science, software, data, and metadata to other intelligent devices and third party components and devices so that data or decision science, whether real-time, batch, or manual processing, can be updated and data or decision science driven queries, recommendations and autonomous actions can be broadcasted to other intelligent devices and third party systems in real-time.

### CROSS-REFERENCE TO RELATED APPLICATIONS

The present application claims priority to U.S. Provisional Patent Application No. 62/472,349 filed on Mar. 16, 2017 and titled “Systems and Methods for Managing Extreme Data”; U.S. Provisional Patent Application No. 62/483,290 filed on Apr. 7, 2017 and titled “System and method for intelligently processing, AI analyzing and learning, and autonomously taking actions using data from edge devices, IoT devices, enterprise data, and third party, and other systems data”; U.S. Provisional Patent Application No. 62/528,014 filed on Jun. 30, 2017 and titled “Intelligent Endpoint Systems For Managing Extreme Data”; and U.S. Provisional Patent Application No. 62/540,499 filed on Aug. 2, 2017 and titled “Smart Distributed Systems For Managing Network Data”, and the entire contents of these patent applications are herein incorporated by reference.

### TECHNICAL FIELD

The following generally relates to processing extreme data using edge devices, and systems and methods involving edge devices.

### DESCRIPTION OF THE RELATED ART

The global proliferation and adoption of electronic devices creates more data than can be stored. Furthermore, data computation growth surpasses Moore's Law for global computation and the amount of data transmitted across networks and stored exceeds projected network bandwidth and data storage availability. In one recent analysis, 700 million users plus 20 billion Internet-of-Things (IoT) devices equated to approximately 4.5×10²³ interconnections among users and devices, a number which does not even include the actual data and the enriched metadata corresponding to the actual user-created data, machine data, and IoT data. Thus, 4.5×10²³, while a vast number, is only a portion of the data. We can refer to this type of data “Extreme” or “Explosive” Data (XD), which may refer to data that continues to exponentially grow and change.

Current implementation of XD environments attempts to perform real-time data or decision science operations by sending all XD to one or a few nodes in order to make automated, intelligent decisions and/or autonomous actions. This approach is similar to conventional mainframe “hub and spoke”, batch data, or traditional decision science processing framework or model. These methods and techniques process and analyze XD by transmitting data from one end point (i.e., the point of data creation) through networks to another end point, and processing XD (e.g., capturing, indexing, storing, and graphing, to name a few steps) at that other end point. This process involves significant time delay, especially when dealing with XD and related content. Hence, meaningful real-time decisions are challenging—especially those that are based on application of machine learning and artificial intelligence—despite faster networks and computing technologies.

Furthermore, the aforementioned approach requires transmitting or receiving XD and related metadata through various networks, which requires large computing resources and bandwidth. However, the majority of such data is actually noise, wherein “noise”, in this context, may refer to duplicate data or “known known” data.

Time lag also increases exponentially since new data or decision science models are performed, for example, at the end of the network (e.g., edge nodes). Moreover, once data/decision science is completed, the completed results need to travel back through the network and ultimately back to the user(s) or other edge nodes, systems, and the like. Conventional methods, consequently, reinforce the extended user latency to perform data or decision science against inbound data and ultimately lengthen the time to receive, for example, real-time business recommendations and actions.

### SUMMARY

In light of these problems, a different computing approach is provided herein to analyze and recommend actions based on Extreme or Explosive Data (XD). In particular, an “Intelligent” XD Ecosystem may comprise “Intelligent Devices,” which can otherwise be referred to as “Intelligent Edge Nodes” that can be used to externalize and distribute data or decision science driven analysis to where data may be first created, and autonomously make decisions and take autonomous actions using computing systems and devices, networks and devices, and electronic devices and components, at each compute chain of events. The compute chain of events may include any step that involves distributed computation, data processing, data manipulation, or data transmission. As used herein, “Intelligent Devices” may generally refer to devices in the compute chain of events that can be equipped with data or decision science capabilities to make timely (e.g., in real-time or near real-time) decisions and actions, wherein each device may be distributed across various networks or nodes.

In an example aspect, an Intelligent XD Ecosystem can facilitate intelligent decisions, make recommendations and autonomous decisions, and take autonomous actions sooner and faster. In particular, such an approach, as disclosed herein, can be used to provide a technical solution that can efficiently make distributed, decision science based recommendations and actions across network nodes and related devices, and can provide increasingly smarter recommendations and actions over time. For example, currently available methods of creating and uploading XD to the public cloud (e.g., off premises databases, immutable ledger databases) may take an extensive amount of time, and consequently many business entities or individuals opt to delete a large portion of the XD due to high operational costs and inefficiencies. This can adversely impact the ability to train and perform systems and/or devices for deep learning/machine learning applications given the expense to store and/or transmit XD. The systems and related methods disclosed herein can be used to facilitate intelligent decision making along the whole chain of compute, which enables the efficient and timely application of machine learning, deep learning, and related artificial intelligence techniques.

In another example aspect, the Intelligent XD Ecosystem, in coordination or combination with Intelligent Devices help efficiently distribute computing resources and network bandwidth. The approach disclosed herein involves performing data analysis and applying decision science at each compute step. In an example aspect, Intelligent Devices thereby only transmit or receive data/information that is necessary, valuable, or important for the specific application, device, system, etc. For example, other “known known” data may be discarded, saving network bandwidth resources.

An Intelligent XD Ecosystem and related method can be thought of as a pivot and extension to an economist's premise of “perfect” information, a feature of perfect competition. With perfect information in a market, all consumers and producers are assumed to have perfect knowledge of price, utility, quality and production methods of products, when theorizing the systems of free markets, and effects of financial policies. For instance, the Bloomberg terminal, which integrates and displays all global exchanges (stock markets, currency, natural resources, etc.), global news that impacts industries and companies, and the ability to buy and sell on these exchanges, exemplifies an economic “perfect information” technology platform.

An Intelligent XD Ecosystem and related methods as disclosed herein extends this concept of a “perfect information” technology platform beyond the financial industry. In particular, the Intelligent XD Ecosystem provides perfect information characteristics in Intelligent Edge Nodes, and the system or systems that are made of these Intelligent Edge Nodes, using data that is created, transmitted, received, and manipulated by computing devices, networks, and components. The Intelligent Edge Nodes and the collaborations of these Intelligent Edge Nodes as a system are able to, for example, manage data, understand data, and execute preemptive and autonomous decisions and actions by knowing or understanding what signals to listen for. By taking automated actions through the use of distributed intelligence, the Intelligent XD Ecosystem and methods as disclosed herein greatly improve the ability and efficiency of managing XD.

The Intelligent XD Ecosystem and methods include a computer platform that can make distributed and autonomous decision science based recommendations and actions that can increasingly become smarter and faster (e.g., improvement through machine learning) over time. The Intelligent XD Ecosystem computing platform involves sensing, monitoring, learning, analyzing, and taking actions in order to attain “perfect information” or near-perfect information of devices and systems within the network and along the chain of compute, and make timely technical or business decisions. The sheer number of computing devices, components, and networks accessed and managed by the Intelligent XD Ecosystem is, in an example embodiment, vastly greater than the number of stock exchanges, currencies, news outlets, and other economic components managed by the Bloomberg platform. If one attempted sensing, monitoring, analyzing, learning, and taking autonomous actions on all of this aforementioned data using the current systems and methods, disproportionate computing and network resources and time would be spent computing (e.g., receiving information, computing, storing, indexing, and applying data science) against the information. The time lag between ingesting and indexing information relative to actually performing data or decision science and taking preemptive actions would render the current systems and computational methods untimely and in some cases useless.

In an example aspect, the Intelligent Edge Nodes autonomously and collaboratively execute computations for recording, verifying and acting upon immutable data in an immutable ledger ecosystem, which is the Intelligent XD Ecosystem. One or more these Intelligent Edge Nodes in the Intelligent XD Ecosystem sense the immutable data, monitor the immutable data, analyze the immutable data, store or index (or both) the immutable data, apply data science in relation to the immutable data, and taking autonomous actions in relation to the immutable data.

In another example aspect, the Intelligent XD Ecosystem and methods apply a sliding scale 80/20 decision making allocation for distributed intelligent decisions and actions, whereby 80% of the intelligent decisions and actions can be distributed away (e.g., to other peripheral devices, systems, and networks) from a central computing platform. Over time, the decisions and actions can be gradually distributed closer to where the data originated, sensed, or created. Sending data to one or a few computing platforms and making decisions based upon all of this received data can inevitably take too long to provide a timely and relevant action. In another embodiment, the Intelligent XD ecosystem can apply data science to limit the number of devices (example: distributed immutable ledgers) that get updated because data science (STRIPA and machine learning) determined and recommended N number of specific distributed immutable ledgers are more than sufficient to be trusted for a given use case.

In another example aspect, the Intelligent XD Ecosystem and related methods as disclosed herein “extend intelligence” (e.g., by equipping, embedding, applying, installing, updating, etc. data or decision science hardware and software capabilities) to all electronic devices including but not limited to computers, smart phones, TVs, appliances, networks, electronically controlled machines and processing equipment, IoT devices, and other electronic devices, including various components included in the respective devices. For example, Graphics Processing Units (GPUs), neuromorphic chips, Field Programmable Gate Arrays (FPGAs), Tensor Processing Units (TPUs), ASICs, amongst others, are examples of hardware processors that execute machine learning computations. For example, these types of processors enable Intelligent Edge Nodes to perform localized facial recognition, as opposed to sending data to a vast computing platform. Therefore, using the Intelligent Edge Nodes, intelligence and actions are executed closer to the point/location where data is initially sensed or created, or both.

Furthermore, digital electronic components, or analog electronic components or analog hardware (e.g. mechanical hardware, chemical devices, etc.) connected to or equipped with digital computing components, or both, that make up the aforementioned devices such as power supplies, microprocessors, RAM, disk drives, resistors, relays, capacitors, diodes, and LED screens, can also be equipped with computing intelligence. In the context of analog devices, such as a power transformer, has a built in current sensor or temperature sensor that provides sensor data (e.g. local data) to a processor with computing intelligence; the collective of these devices forms an intelligent edge node. In the context of a digital electronic components, the number of read and write actions (e.g. local data) are counted in a RAM device or a cache device in a chip, which provides an indication of the wear or remaining lifespan of the device, and this local data is processed by a processor with computing intelligence; the collection of these devices forms and intelligent edge node. Computing intelligence may require a combination of various components, databases, storage, immutable ledgers, blockchains, ledgerless blockchains, and systems, wherein data or decision science capabilities can be embedded or installed. Self-stacking nano-technology can potentially facilitate designing and manufacturing intelligent components previously limited to only processor-like devices (CPUs, GPUs, TPUs, FPGAs, etc.). This nanotechnology can further support the 80/20 decision making allocation for distributed intelligent decisions and actions by enabling these previously unintelligent or “dumb” electronic devices to, for example, self-monitor, run self-diagnostics, and communicate status information before the part itself may become subject to failure. Alternatively, this same intelligence running on previously dumb devices can inevitably lead to a whole new level of in-circuit and embedded sensors as more and more devices and components move into nanotechnology.

Additionally, an Intelligent XD Ecosystem and method as disclosed herein can enable varying degrees of autonomous intelligence and actions. Attempting to ingest and make timely decisions based upon trillions of computing devices and component network data can be a futile effort. Instead, the Intelligent XD Ecosystem and method can provide “governance intelligence,” which may refer to master databases and or immutable blockchain ledgers (either distributed or centralized) comprising for example, business or technical policies, guidelines, rules, metrics, and actions. This governance intelligence can enable sets and subsets of computing and network devices, electronic devices and their components to make distributed and localized decisions and actions that support the overarching nominal policies, guidelines, rules, actions specified by the “governance” intelligence.

In an example aspect, a system for managing vast amounts of data (e.g. metadata, immutable ledgers and records, unstructured and structured data, video, image, audio, text, biometric data, biomedical data, brain-computer interface data, satellite data, other sensor data, etc.) in order to provide distributed and autonomous decision based actions can comprise: a plurality of intelligent edge nodes (e.g. which, in some embodiments, are considered immutable ledger nodes), wherein at least one of the plurality of intelligent edge nodes is inserted at a point where local data is first created and wherein the at least one of the plurality of intelligent edge nodes is configured to perform localized decision science related to the local data; a plurality of intelligent networks for transmitting data to and from the at least one of the plurality of intelligent edge nodes, wherein at least one of the plurality of intelligent networks has embedded intelligence and wherein the transmitted data is based at least in part on the local data; and a plurality of intelligent message buses interconnected with the at least one of the plurality of intelligent edge nodes and the at least one of the intelligent networks, wherein at least one of the plurality of intelligent message buses are configured to perform autonomous actions based at least on the transmitted data.

In an example embodiment, the intelligent edge node further includes output capabilities, such as display capabilities (e.g. light projector, display screen, augmented reality projectors or devices, etc.) and audio output capabilities (e.g. audio speaker). In an example embodiment, an intelligent edge node includes one or more media projectors, one or more audio speakers, one or more microphones, and one or more cameras, with voice recognition capabilities and image recognition capabilities.

In some example embodiments, the at least one of the plurality of intelligent edge nodes that can be configured to create local data and to execute the localized decision science to evaluate the local data. In some example embodiments, the at least one of the plurality of intelligent networks may have the ability to communicate with other intelligent networks, make autonomous network decisions, and/or take autonomous network actions.

In some example embodiments, the evaluation of the local data may comprise making a determination as to whether the local data is known known or an anomaly.

In some example embodiments, the at least one of the plurality of intelligent edge nodes may be configured to discard the local data if the local data is determined to be known known. In some example embodiments, the at least one of the plurality of intelligent edge nodes can be configured to update a local and/or global data store, data science, graph database, immutable ledger or blockchain (or both), or third party system with the local data based at least on determining whether data is a known known or unknown.

In some example embodiments, the at least one of the plurality of intelligent edge nodes can be configured to update data science across one or more data stores, applications, immutable ledgers or blockchains (or both), systems, and third-party systems. In other example embodiments, the at least one of the plurality of intelligent edge nodes is configured to query one or more non-local systems to evaluate data from other non-local systems, wherein the evaluate comprises determining whether the data is known or unknown, and wherein the non-local systems comprise data store, data science, immutable ledger or blockchain (or both), graph database, index, memory, or application.

In some example embodiments, the at least one of the plurality of intelligent edge nodes can be configured to update tags or references for the local data to existing local data stored locally and/or to other global intelligent edge nodes, data stores, applications, immutable ledgers or blockchains (or both), systems, and third-party systems based at least on determining whether the local data is a known known or unknown.

In some example embodiments, the at least one of the plurality of intelligent edge nodes can be configured to send a message related to the local data via the at least one of the intelligent message buses based at least on determining whether the local data is a known known or an unknown. In other example embodiments, the at least one of the plurality of intelligent edge nodes can be configured to autonomously send the message and/or take actions related to the local data via the at least one of the plurality of intelligent message buses.

In some example embodiments, the at least one of the plurality of intelligent edge nodes can be configured to make an autonomous decision or to take an autonomous action in response to the evaluation of data comprising one or more of the local data, and/or data transmitted from other data stores, applications, immutable ledgers or blockchains (or both), systems and third-party systems. In some example embodiments, the evaluation of the local data and/or data transmitted from other data stores, applications, systems, immutable ledgers or blockchains (or both) and third-party systems can be determined in response to an application selected from the group consisting of business rules, data science, computing requirements, and workflow actions applied to the local data.

In some example embodiments, the at least one of the plurality of intelligent edge nodes can be configured to autonomously update a local data store, an immutable ledger or a blockchain (or both), data science, graph database, application, index, and memory to include the local data if the local data is determined to be an anomaly.

In other example embodiments, the at least one of the plurality of intelligent edge nodes can be configured to autonomously update the one or more non-local systems to include the local data if the local data is determined to be an anomaly, wherein the non-local systems comprise a data store, data science, a graph database, an immutable ledger or blockchain (or both), index, memory, or app.

In some example embodiments, the evaluation of the local data can comprise automatically communicating and querying each of the plurality of intelligent edge nodes and/or one or more data stores, applications, data science, systems, immutable ledgers or blockchains (or both), and third-party systems to determine if the local data is a known known or an anomaly.

In some example embodiments, the at least one of the plurality of intelligent edge nodes can be configured to update a local data store, data science, graph database, immutable ledger or blockchain (or both), index, memory, or app, to include the local data if the query results from each of the plurality of intelligent edge nodes comprise no answers.

In some example embodiments, the at least one of the plurality of intelligent edge nodes can be configured to autonomously send a message related to the local data and or one or more data stores, data science systems, applications, immutable ledgers and third-party systems through at least one of the plurality of intelligent networks if the query results from each of the plurality of intelligent edge nodes comprise no answers.

In some example embodiments, the at least one of the plurality of intelligent edge nodes can be configured to autonomously update a local data store, data science, graph database, immutable ledger or blockchain (or both), index, memory, or app, to include the local data and or non-local data store, applications, systems, and third-party systems, and optionally to take a corresponding autonomous decisions and/or autonomous action if the query results from at least another one of the plurality of intelligent edge nodes responds with answers indicating the data is known or unknown. In some embodiments, the corresponding action is in response to an evaluation of the local data and/or one or more non-local data stores, applications, systems, immutable ledgers or blockchains (or both) and third-party systems. In some embodiments, the evaluation of the local data may be determined in response to an application selected from the group consisting of business rules, data science, computing requirements, and workflow actions applied to the local data and/or non-local data stores, immutable ledgers or blockchains (or both), applications, systems, and third-party systems.

In some example embodiments, some or all of the aforementioned intelligent edge node embodiments can be configured to use immutable technologies (such as, but not limited to, blockchains), which involve anonymous, immutable and encrypted ledgers and records that span over N number of intelligent edge nodes. These distributed ledgers, which are distributed in over multiple intelligent edge nodes, can be in the form of blockchains or other types of currently-known and future-known immutability protocols. These immutable ledgers can reside in RAM, cache, solid state, and spinning disk drive stores. In an alternative embodiment, these aforementioned stores can span across an ecosystem of store devices involving technologies such as Memcached, Apache Ignite; graph databases such as Giraph, Titan, and Neo4j, and structure and unstructured data stores such as Hadoop, Oracle, MySQL, etc.

In some example embodiments, the compute related to the immutable technologies, which is intrinsically compute intensive, can span a plurality of intelligent edge nodes in order to distribute the computing intensity.

In an alternative example embodiment these immutable intelligent edge nodes can be configured to autonomously update a local data store, data science, graph database, index, memory, or app, to include the local data and or non-local data store, applications, systems, other immutable ledgers, and third-party systems, and optionally to take a corresponding autonomous decisions and/or autonomous action if the query results from at least another one of the plurality of intelligent edge nodes (e.g. which can be an immutable intelligent edge node or not an immutable intelligent edge node) responds with answers indicating the data is known or unknown.

In an example embodiment, the intelligent edge nodes include one or more of: human-computer interfaces (e.g. including brain-computer interfaces), devices controlled by human-computing interfaces, sensors that provide data to human-computer interfaces, and devices in communication with human-computer interfaces.

In an example processing or manufacturing embodiment, the intelligent edge nodes include one or more of: devices that process or manufacture objects; devices that analyze the objects; devices that monitor the objects; devices that transport the objects; devices that store the objects; and devices that monitor, analyze, repair, install, remove, or destroy, or any combination thereof, any of the other aforementioned devices.

In an example aspect, the intelligent edge nodes are part of a manufacturing system. In another example aspect, the intelligent edge nodes are part of a processing system for human-consumable products (e.g. food, cosmetics, drugs, supplements, etc.).

These and other embodiments are described in further detail in the following description related to the appended drawing figures.

### BRIEF DESCRIPTION OF THE DRAWINGS

Embodiments will now be described by way of example only with reference to the appended drawings wherein:

FIG. 1 shows an example Intelligent XD Ecosystem according to an embodiment described herein;

FIG. 2A shows a flowchart for a method for managing XD according to an embodiment described herein;

FIG. 2B shows a flowchart for a method for evaluating XD according to an embodiment described herein;

FIG. 2C shows a flowchart for a method for querying other Intelligent Devices according to an embodiment described herein;

FIG. 3 shows a flowchart for another method for managing XD according to an embodiment described herein; and

FIG. 4 shows a flowchart of a method for updating an Intelligent Device, according to an embodiment described herein.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

A method and system is provided that can analyze and recommend solutions based on Extreme or Explosive Data (XD). XD, as used herein, may generally refer to data that is vast, increasing in size at an increasing rate, and/or changing over time, usage, location, etc. This data includes structured data, unstructured data, text, metadata, hashtags, video data, audio data, image data, system journals, immutable ledger data or blockchain data (or both), record data, biometric data, biomedical data, satellite data, other sensor data, and any combination of the aforementioned. The devices, systems and methods as disclosed herein can make distributed, data or decision science based recommendations and actions and can make increasingly smarter recommendations and actions over time.

The multiple intelligent edge nodes form one or more systems that can apply data or decision science to perform autonomous decisions and/or actions across these nodes (e.g. computing systems and devices, networks and devices, and electronic devices and components, and any one or more combinations thereof). In an example embodiment, subsystems of intelligent edge nodes are formed and these subsystems in term interact with each other to form one or more larger intelligent systems. Data science or decision science may refer to math and science applied to data including but not limited to algorithms, machine learning, artificial science, neutral networks, and any other math and science applied to data. The results from data or decision science include, but are not limited to, business and technical trends, recommendations, actions, and other trends. Data or decision science includes but is not limited to individual and combinations of algorithms (“algos”), machine learning (ML), and artificial intelligence (AI), to name a few. This data or decision science can be embedded, for example, as microcode executing inside of processors (e.g. CPUs, GPUs, FPGAs, TPUs, neuromorphic chips, ASICs), scripts and executables running in operating systems, applications, subsystems, and any combinations of the aforementioned. Additionally, this data or decision science can run as small “micro decision science” software residing in static and dynamic RAM memory, EPROMs, solid state and spinning disk storage, and aforementioned systems that span a number of nodes with the aforementioned memory types and with different types of memory. A method for applying data and decision science to evaluate data can include, for example, Surface, Trend, Recommend, Infer, Predict and Action (herein called STRIPA) data or decision science. Categories corresponding to the STRIPA methodology can be used to classify specific types of data or decision science to related classes, including for example Surface algos, Trend algos, Recommend algos, Infer algos, Predict algos, and Action algos. Surface algos, as used herein, may generally refer to data science that autonomously highlights anomalies and/or early new trends. Trend algos, as used herein, may generally refer to data science that autonomously performs aggregation analysis or related analysis. Recommend algos, as used herein, may generally refer to data science that autonomously combines data, metadata, and results from other data science in order to make a specific autonomous recommendation and/or take autonomous actions for a system, user, and/or application. Infer algos, as used herein, may generally refer to data science that autonomously combines data, metadata, and results from other data science in order to characterize a person, place, object, event, time, etc. Predict algos, as used herein, may generally refer to data science that autonomously combines data, metadata, and results from other data science in order to forecast and predict a person, place, object, event, time, and/or possible outcome, etc. Action algos, as used herein, may generally refer to data science that autonomously combines data, meta data, and results from other data science in order to initiate and execute an autonomous decision and/or action.

Data or decision science examples may include, but are not limited to: Word2vec Representation Learning; Sentiment multi-modal, aspect, contextual; Negation cue, scope detection; Topic classification; TF-IDF Feature Vector; Entity Extraction; Document summary; Pagerank; Modularity; Induced subgraph; Bi-graph propagation; Label propagation for inference; Breadth First Search; Eigen-centrality, in/out-degree; Monte Carlo Markov Chain (MCMC) sim. on GPU; Deep Learning with R-CNN; Torch, Caffe, Torch on GPU; Logo detection; ImageNet, GoogleNet object detection; SIFT, SegNet Regions of interest; Sequence Learning for combined NLP & Image; K-means, Hierarchical Clustering; Decision Trees; Linear, Logistic regression; Affinity Association rules; Naive Bayes; Support Vector Machine (SVM); Trend time series; Burst anomaly detect; KNN classifier; Language Detection; Surface contextual Sentiment, Trend, Recommendation; Emerging Trends; Whats Unique Finder; Real-time event Trends; Trend Insights; Related Query Suggestions; Entity Relationship Graph of Users, products, brands, companies; Entity Inference: Geo, Age, Gender, Demog, etc.; Topic classification; Aspect based NLP (Word2Vec, NLP query, etc); Analytics and reporting; Video & audio recognition; Intent prediction; Optimal path to result; Attribution based optimization; Search and finding; and Network based optimization.

An Intelligent XD Ecosystem as disclosed herein can comprise Intelligent Devices, which may also be referred herein as Intelligent Edge Nodes. Each of these Intelligent Devices (“devices” herein may refer to any edge nodes/devices, transceivers, receivers, message bus, networks, network devices, electronic devices, data stores, 3rd party systems, internal systems, immutable ledger nodes, or any other electronic component) can optionally have the ability to transmit and/or receive (e.g. via the Intelligent Transceiver) new data or decision science, software, data, immutable records, and metadata to one or more other Intelligent Devices and third party companies and devices so that data or decision science—whether real-time, batch, or manual processing—can be updated and data or decision science driven queries, recommendations and autonomous actions can be broadcasted to other Intelligent Devices and third party systems in real-time or near real-time. Intelligent Transceivers can facilitate faster data or decision science updates by accelerating eminent trends, alerts, messages, and preemptive business and technical communication and corresponding actions. Intelligent Devices can optionally use an Intelligent Device Message Bus to communicate certain types of messages (e.g. business alerts, system failures) to other Intelligent Devices, wherein the Intelligent Message Bus may refer to a message bus embedded with or configured to perform data or decision science capabilities.

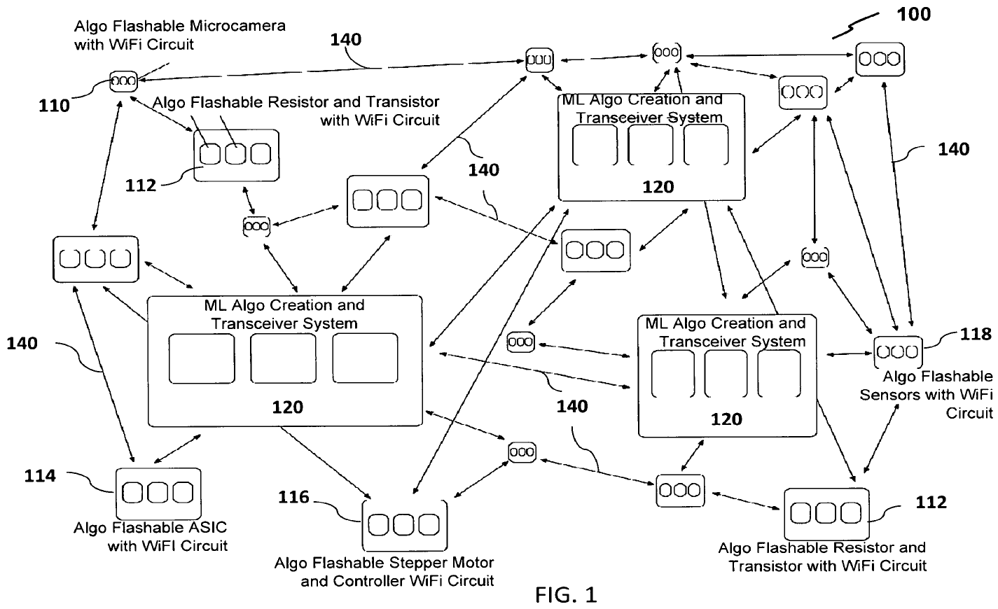

FIG. 1 shows an Intelligent XD Ecosystem 100 comprising various types of Intelligent Devices represented by different sized boxes, according to an embodiment described herein. Intelligent XD Ecosystem may comprise a plurality of Intelligent Devices (i.e., intelligent edge nodes), Intelligent message buses, and networks. The various Intelligent Devices can be dispersed throughout an Intelligent XD Ecosystem 100. Similar to a human brain with neurons and synapses, neurons can be considered akin to Intelligent Edge Nodes and synapses can be considered akin to Intelligent Networks. Hence, Intelligent Edge Nodes are distributed and consequently support the notion of distributed decision making—an important step and embodiment in performing XD decision science resulting in recommendations and actions. However, unlike the synapses of a human brain, the Intelligent Networks in an Intelligent XD Ecosystem as disclosed herein can have embedded “intelligence”, wherein intelligence can refer to the ability to perform data or decision science, execute relevant algorithms, and communicate with other devices and networks. For example, Intelligent Networks can be configured to execute one or more data or decision science algorithms based at least on the network traffic or network flow related data.

Intelligent Edge Nodes are a type of an Intelligent Device, and can comprise various types of computing devices or components such as processors, memory devices, storage devices, sensors, or other devices having at least one of these as a component. Intelligent Edge Nodes can have any combination of these as components. In an example aspect, one or more of the aforementioned components within a computing device have data or decision science embedded in the hardware. For example: microcode data or decision science runs in a GPU or other type of processor; data or decision science runs within the operating system and applications; and data or decision science runs as software complimenting the hardware and software computing device; or a combination thereof. In another embodiment, all of the aforementioned components within a computing device have data or decision since embedded in the hardware.

As shown in FIG. 1, an Intelligent XD Ecosystem 100 can comprise various Intelligent Devices or Intelligent edge nodes including, but not limited to, for example, an Algo Flashable Microcamera with WiFi Circuit 110, an Algo Flashable Resistor and Transistor with WiFi Circuit 112, an Algo Flashable ASIC with WiFi Circuit 114, an Algo Flashable Stepper Motor and Controller WiFi Circuit 116, Algo Flashable Circuits with WiFi Sensors 118, and an ML Algo Creation and Transceiver System 120. Intelligent Devices listed above may be “Algo Flashable” in a sense that the algorithms (e.g., data or decision science related algorithms) can be installed, removed, embedded, updated, loaded into each device.

Each Intelligent Device in an Intelligent XD Ecosystem can perform general or specific types of data or decision science, as well as perform varying levels (e.g., complexity level) of computing capability (data or decision science compute, store, etc.). For example, Algo Flashable Sensors with WiFi circuit 118 may perform more complex data science algorithms compared to those of Algo Flashable Resistor and Transistor with WiFi circuit 112, or vice versa. Each Intelligent Device can have intelligent components including, but not limited to, intelligent processors, RAM, disk drives, resistors, capacitors, relays, diodes, and other intelligent components. Intelligent Networks 140 (represented as bi-directional arrows in FIG. 1) can comprise one or more combinations of both wired and wireless networks, wherein an Intelligent Network includes intelligence network devices, which are equipped with or configured to apply data or decision science capabilities.

Each Intelligent Device can be configured to automatically and autonomously query other Intelligent Devices in order to better analyze information and/or apply recommendations and actions based upon, or in concert with, one or more other Intelligent Devices and/or third party systems. This exemplifies applying perfect or near perfect information as described above, by using as much data and data or decision science prior to taking an action given all information that is available at that specific moment.

Each Intelligent Device can also be configured to predict and determine which network or networks, wired or wireless, are optimal for communicating information based upon local and global parameters including but not limited to business rules, technical metrics, network traffic conditions, proposed network volume and content, and priority/severity levels, to name a few. An Intelligent Device can optionally select a multitude of different network methods to send and receive information, either in serial or in parallel. An Intelligent Device can optionally determine that latency in certain networks are too long or that a certain network has been compromised, for example, by providing or implementing security protocols, and can reroute content using different encryption methods and/or reroute to different networks. An Intelligent Device can optionally define a communication path via for example nodes and networks for its content. An Intelligent Device can optionally use an Intelligent Message Bus to communicate certain types of messages (e.g. business alerts, system failures) to other Intelligent Devices. One or more Intelligent Message Buses can connect multiple devices and/or networks.

Each Intelligent Device can optionally have an ability to reduce “noise” and in particular, to reduce XD that is “known known” data or data that is duplicative. “Known known” data can be in the form of both known data as well as but not limited to preexisting known answers, recommendations, trends, or other data that is already known or adds no new information. Noise in this context may refer to duplicate data or known known data. The premise is that if the data is identical or is within a certain tolerance level or meets certain business rule conditions or other pre-defined nominal state, then there may not be a need to transmit, store, and/or compute such duplicative data. An Intelligent Device can apply, for example, System on Chip (SOC) or DSP-like filters to analyze and discard duplicative or duplicative-like data (e.g., “known known” data) throughout an Intelligent XD Ecosystem 100, thereby eliminating the need to transmit or process such data in the first place. This can reduce network traffic, improve computing utilization, and ultimately facilitate the application of efficient real-time data or decision science with autonomous decisions and actions. This reduction of XD, especially at the local level or through a distributed XD ecosystem, may provide an Intelligent Device XD Ecosystem the ability to identify eminent trends and to make preemptive business and technical recommendations and actions faster, especially since less duplicative data or XD allows for faster identification and recommendations.

Each Intelligent Device can include data or decision science software including but not limited to operating systems, applications, immutable ledgers, and databases, which directly support the data or decision science driven Intelligent Device actions. Linux, Android, MySQL, Hive, and Titan or other software could reside on SoC devices so that the local data or decision science can query local, on device, related data to make faster recommendations and actions.

Each Intelligent Device can optionally have an Intelligent Policy and Rules System. The Intelligent Policy and Rules System provides governing policies, guidelines, business rules, nominal operating states, anomaly states, responses, Key Performance Indicator (KPI) metrics, and other policies and rules so that the distributed IDC devices can make local and informed autonomous actions following the perfect information guiding premise as mentioned above. A number (e.g., NipRs) of Intelligent Policy and Rules Systems can exist, and the aforementioned systems can have either identical or differing policies or rules amongst themselves or alternatively can have varying degrees or subsets of policies and rules. This latter alternative is important when there are localized business and technical conditions that may not be appropriate for other domains or geographic regions.

### Systematic Walkthrough of Intelligent XD Ecosystem and Devices

For clarity of presentation, rather than sending all the XD through the network and computing devices, the Intelligent XD Ecosystem and related methods are exemplified and described with a focus on solving the aforementioned XD situation by decomposing this situation into two basic phases.

Phase 1:

Intelligent Edge Node Configuration

As shown in FIG. 1, an Intelligent XD Ecosystem can comprise an Intelligent Edge Node that can create local data and can perform localized data or decision science related to the local data. Thus, in a first phase or phase one (1) of a method for managing XD, an Intelligent Edge Node can be configured to create local data and to perform localized data or decision science related to the local data. In particular, Intelligent Edge Nodes can be configured to create local data by provisioning such nodes for example, with enough processor(s), memory, and disk store in order to support, for example, a small indexer, small database, and small graph database. The memory can include, but is not limited to RAM, solid state disk, and rotational disk. The memory can span over a number (N_{EN}) of edge nodes using software such as Apache Ignite. Intelligent Device edge compute devices can also be provisioned for example, with localized data or decision science (e.g. algos, ML, AI, and other data or decision science) using localized processors including but not limited to CPUs, GPUs, TPUs, neuromorphic chips, FPGAs, ASICs, quantum processors and other localized processors as known in the art or yet to be developed.

To perform localized data or decision science related to the local data, Intelligent edge nodes or Intelligent edge compute devices can execute the localized decision science within a processor such as, for example, microcode running inside of a CPU(s), GPU(s), FPGA(s), TPU(s), neuromorphic chip(s), ASIC(s); by executing code in RAM, EEPROM, solid state disks, rotational disks, cloud based storage systems, storage arrays; by executing code spanning a number of edge nodes using software such as Apache Ignite; and by executing code spanning a number of the aforementioned processor, memory, and store combinations.

Data Processing

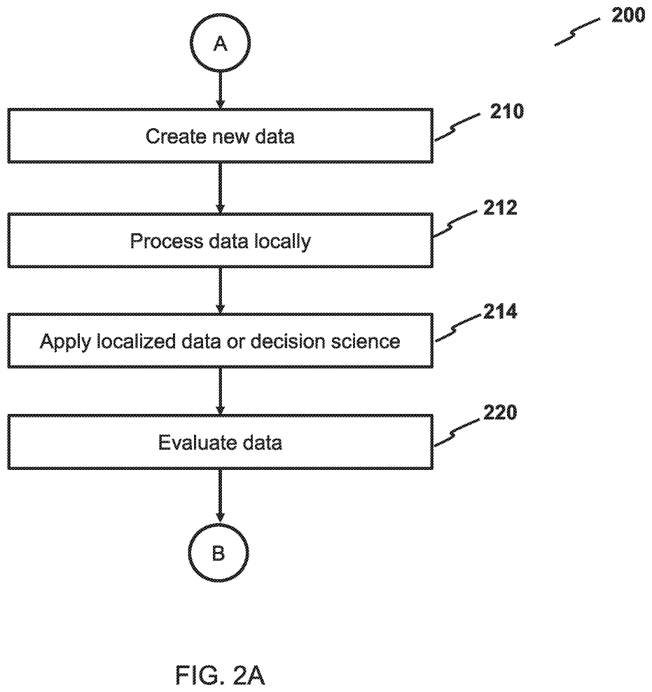

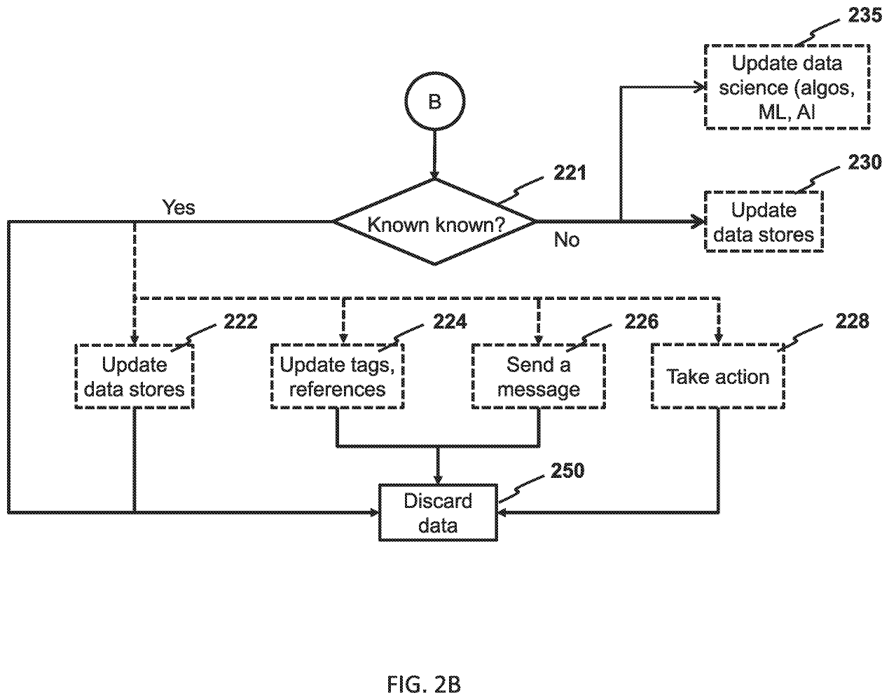

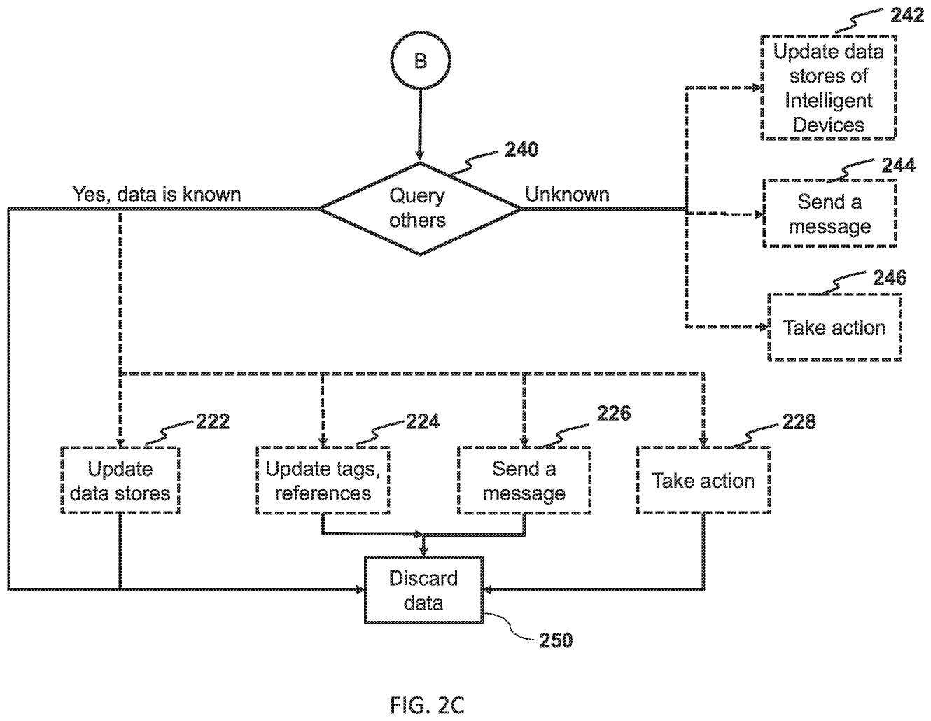

FIG. 2 shows a flowchart for a data processing method 200 for managing XD, according to an embodiment described herein. First, an Intelligent Device (e.g., an edge node device) can begin at 210 by creating new data (e.g. machine data, biological-related data, system logs, user generated related data, meta data, multimedia data and meta data, sensor and IoT related data, immutable ledger or block data or both, any other form of new data, any combination of the aforementioned data types). As the data is locally generated, the data can immediately be fed at 212 directly (as opposed to transmitting directly to other nodes in the network) into the Intelligent Device's local processors, RAM, memory or other local components or any other combination thereof, in real-time or batch mode or any combination of both real-time and batch mode for local processing. As the data is fed into the local components (e.g. processors, memory, and/or disk), the localized data or decision science, running on this intelligent edge node, can be applied at 214 to this local data.

### Example 1: Local Decision Science Applied to Locally Generated Data

Applying data or decision science to the locally created data may involve one or more various operations to evaluate the data (operation 220). FIG. 2B shows a flowchart for a method for evaluating locally generated data, according to an embodiment described herein. In one embodiment, as shown in FIG. 2B, the inbound data can be evaluated to determine whether it is a known known or whether it is an anomaly or a new unknown.

The inbound data can be determined to be a known known at 221, for example, if the inbound data is based on existing data, answers, data science, or rules residing in the local memory, index, database, graph database, immutable ledger or blockchain (or both), apps or other local memory or storage components. If the inbound data is determined to be known known, then the components and/or Intelligent Devices may discard the XD at 250 rather than send or transmit this data through networks (e.g., Intelligent Networks) and other Intelligent edge nodes. This operation eliminates unnecessary network bandwidth usage and computing/storing usage.

In some embodiments, at 222 the local Intelligent edge node can update the local and/or global data stores, graph databases, data science systems, immutable ledgers or blockchains (or both), or third party systems with this known known data for statistical purposes, for example, before it discards the XD at 250. Such update may provide useful in determining whether any data generated later should be considered, for example, a known known. Alternatively at 224, the local Intelligent edge node can update tags or references or immutable ledger records for this known known data to existing known known data stored locally and/or to other global Intelligent edge nodes, for example, before it discards the XD at 250. An alternative embodiment is that the local Intelligent edge node can send a message at 226 related to this known known data, via a data or decision science driven message bus (e.g., Intelligent Message Bus) application, for example, and then the local Intelligent edge node can discard the primary data.

In some embodiments, at 228 the local Intelligent edge node can take an action, including but not limited business rules, computing requirements, workflow actions, or other actions related to this known known data, via a data or decision science driven message bus application, for example, before it discards the XD at 250. Additionally, based on a data type result, the local Intelligent edge node can perform dynamic data determinant switching whereby the data type can drive a certain action, such as a business action or technical response in real-time. For example, if the number of roughly similarly characterized anomalies reach a certain number during a given time window, then an intelligent message alert can be sent to a person or an administrator for deeper analysis or the system may be configured to automatically analyze and diagnose such anomalies.

In addition or in the alternative, the local Intelligent edge node can combine any of the aforementioned embodiments, for example, any of steps 222, 224, 226, and/or 228 before it discards the XD or Extreme data at 250.

If the data is evaluated and determined to be an anomaly or a new unknown at 221, the Intelligent edge node device can update at 230 the local data stores, graph databases, immutable ledgers or blockchains (or both), index, memory, apps, or other data stores to include the anomaly or new unknown.

In some embodiments, as shown in FIG. 2C, the data evaluation step at 220 can comprise the local Intelligent edge node automatically communicating and querying at 240 other edge node(s) to determine if this data is a truly an anomaly or a known known. The local Intelligent edge node can query at 240, for example, other Intelligent edge node(s) or Intelligent synthesizer node(s) or third party systems to determine if data is an anomaly or a known known. If the query results from other Intelligent edge nodes respond with no answers, then all local and global Intelligent edge node data stores, graph databases, memory, apps, immutable ledgers or blockchains (or both), and third party systems can be autonomously updated with the new data at 242 and can take a corresponding autonomous action(s) at 246. If the query results from other Intelligent edge nodes respond with answers indicating the data is known, then the local Intelligent edge node can update its local data store, graph database, index, memory, apps, immutable ledger or blockchain (or both), and third party systems, and can take a corresponding action at 228.

In some embodiments, the local Intelligent edge node can send a message at 244 related to the unknown data, via a data or decision science driven message bus application (e.g., Intelligent Message Bus), to other Intelligent edge nodes, networks (e.g., Intelligent Networks), and third party systems. For example, a message relaying information about a given anomaly or given important event is propagated throughout the Intelligent XD ecosystem so that other Intelligent edge nodes are able to act upon or analyze the information about the given anomaly or given important event.

In some embodiments, at 228 or at 246 the local Intelligent edge node can take an action, including but not limited business rules, data science, computing requirements, workflow actions, or other actions related to this unknown data, via a data or decision science driven message bus application. For example, a workflow action may involve ingesting data, processing the data against data science algorithms, taking the output from the process and providing the data as an input to a downstream (e.g., for a device further down the compute chain) algorithm. Additionally, based on a data type result, the local Intelligent edge node can perform dynamic data determinant switching whereby the data type can drive a certain action, such as a business action or technical response in real-time.

In addition or in the alternative, the local Intelligent edge node can combine any of the aforementioned embodiments, for example, any of steps 221, 222, 224, 226, 228, before it discards the known known XD at 250 and any of the aforementioned embodiments, for example, any of the steps 240, 242, 244 and/or 246 if it determines the XD is an anomaly or is unknown.

### Example 2: Localized Decision Science Applied to Locally Generated Data

Referring to FIG. 2C, if the data is an anomaly, then at 246 the original Intelligent edge node and/or the third party system can prioritize more resources to analyze or evaluate this anomaly based on business rules, data or decision science, computing availability or other operations related considerations. In some embodiments, if the response is that the new anomaly triggers an alert, via a message bus application, for example, the message(s) can be transmitted at 244 to a number (NP) of people, applications, and systems similar to the Pacific Ocean Tsunami alert system.

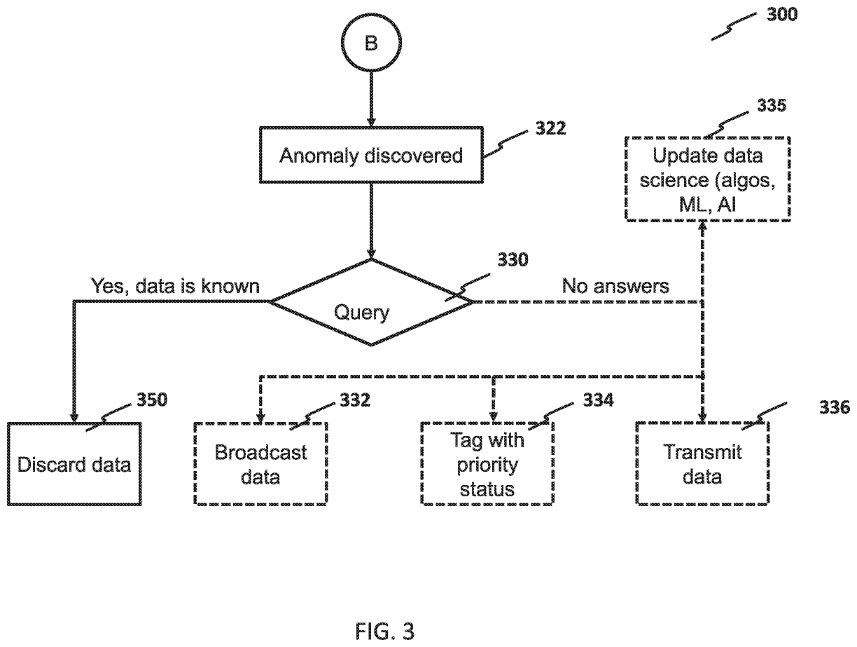

FIG. 3 shows a flowchart for another data processing method 300 for managing XD using Intelligent Devices, according to an embodiment described herein. As shown in FIG. 3, the inbound data can be evaluated to determine whether it is a known known or whether it is an anomaly or a new unknown. In some embodiments, anomaly may be discovered after following the operations described in FIG. 2A-2C. If an anomaly is discovered at 322, the Intelligent Device can apply data or decision science (e.g. the STRIPA methodology) to send queries at 330 to other edge nodes that might know if the anomaly is wide spread (e.g., a known anomaly). If other Intelligent Devices respond and answer that the anomaly preexists and is a known known, then original edge node can proceed to discard the data at 350. If the data is determined to be unknown, for example, or if there are no answers or the response is that the anomaly does not pre-exist, then the data can be broadcasted at 332 to other Intelligent Devices with the new information and/or data or decision science related to the new data.

In some embodiments, the newly discovered data or anomaly can be tagged, marked, or linked at 334 with a priority status for expedited processing. The newly discovered data or decision science patterns can be transmitted at 336 to other Intelligent Devices to facilitate fast discovery and recommended actions. For example, if five (5) new anomalies have occurred in five (5) different locations around the world, the “Infer” decision science (e.g. as part of the STRIPA method) may be applied to determine that the five (5) different anomalies have similar characteristics. Based upon this common denominator anomaly profile, for instance, the Surface decision science (e.g., as part of the STRIPA method) in order to alert systems and/or people of the new potential trend.

In addition or in the alternative, the local Intelligent Device can combine any of the aforementioned embodiments, for example, any of steps 240, 242, 244, 246, and 248 shown in FIGS. 2A-2B in combination with any of steps 322, 324, 326 and 328 shown in FIG. 3.

Data or Decision Science and Software Updates

In some embodiments, Intelligent edge nodes (i.e., Intelligent Devices) can be configured to transmit and/or receive data or decision science and/or software updates using an Intelligent Transceiver. These updates can enable fast and automated, batch or manual software revisions to Intelligent edge nodes indexers, databases, graphs, algorithms, immutable ledgers or blockchains (or both), or data science software, or combinations thereof, as new information is learned or software updates are released. Hence the Intelligent Device components, including IoT devices, edge devices, third party edge nodes and other components not only eliminate XD noise data along the compute processing chain but these same devices get automatically smarter as time elapses by receiving these new software updates and executing these updates in real-time.

Making the response time of these Intelligent Devices smarter over time, is important in order to continually remove and/or tune these devices and edge nodes to better perform embodiments in Examples 1 and 2 as disclosed herein.

In some embodiments, the Intelligent edge nodes can have the ability to at least one of: transmit, receive, or execute data (or a combination thereof); transmit, receive, or execute decision science computations (or a combination thereof); and transmit, receive, or execute software updates (or a combination thereof), from third party systems. Additionally or in the alternative, a third party system can have the ability to transmit and/or receive data or decision science in order to update Intelligent edge nodes and devices. Any combination of the aforementioned can be performed within a method, according to an embodiment described herein.

Phase II:

Intelligent Synthesizer Edge Nodes

The purpose of an Intelligent Synthesizer Edge Node is similar to that of the Intelligent Edge Nodes described in Phase I above. In particular, an Intelligent Synthesizer Edge Node can have the same data or decision science execution, processing, and embodiments as a Phase I Intelligent Edge Node with certain exceptions as detailed below.

First, Intelligent Synthesizer Edge Nodes can have more compute power, memory, and storage capacity. The additional compute capability facilitates more analytic, data science (e.g., ML, AI, algorithms) and general computing power to process and answer more challenging data or decision science questions or immutable computing and recommendations for other Intelligent Edge Nodes and third party systems. In one embodiment, the Intelligent Synthesizer Edge Nodes can take data anomalies from a number (NEN) of Intelligent Edge Nodes and begin performing automated or batch oriented data or decision science, which can result in responses including but not limited to STRIPA based preemptive business recommendations and actions.

In some embodiments, the Intelligent Synthesizer Edge Nodes can approximate missing information and/or data, using a variety of data or decision science techniques, and insert these approximations and estimations into a data store, a graph database, an applications, an immutable ledger or blockchain (or both), or a third party system, or a combination thereof. Intelligent Synthesizer Edge Nodes can also have the ability to transmit and/or receive data or decision science, software updates, and other data from the Intelligent Transceiver. These updates to the Intelligent Synthesizer Edge Nodes can enable fast and automated software revisions to synthesizer indexers, database, graph, immutable ledger, data or decision science, and data as new information is learned or software updates are released from other edge nodes, systems, and third party systems.

For example, it is herein recognized that data in an indexer, a database, a graph, a ledger, or some other data store may be missing. In such scenarios, the Intelligent Synthesizer Edge Nodes execute data science computations to predict or infer the missing data, thus making the data store complete. In other words, the missing data is synthesized and this synthesized data is stored in place of the missing data. These data science computations, for example, can happen in isolation (e.g. only locally) on a given intelligent edge node. In another example, these data science computations occur in a collaborative manner with other intelligent edge nodes. For example, data is obtained from multiple intelligent edge nodes, or data science computations are executed across multiple intelligent edge nodes, or both, in order to predict or infer the missing data for a given intelligent edge node. This synthesized data is then stored on the given intelligent edge node in place of the missing data. T

hese real-time, batch, and manual updates from the Intelligent Transceiver can make the Intelligent Synthesizer Edge Node smarter and faster over time. An Intelligent Synthesizer Edge Node as disclosed herein can comprise any combination of the aforementioned features or embodiments.

Intelligent Third Party Edge Nodes

The purpose of Intelligent Third Party Edge Nodes is to integrate data or decision science computing platforms and ecosystems spanning a number of different ecosystems, platforms, and enterprises. Ecosystems, platforms, and enterprises include but are not limited to strategic business partners, organizations, virtual environments, public and private market places, government organizations, not for profit organizations, anonymous users (immutable technologies and related ecosystems and marketplaces) and other organizations.

In one embodiment, an Enterprise A can have a cloud based system with its own data. Enterprise A may need the expertise of data or decision science focused cloud Business B in order to analyze and recommend data or decision science driven actions. In this case, an Intelligent Third Party Edge Node(s) can be an integration point for Enterprise A and Business B.

This Intelligent Third Party Edge Node can exist in a public or private cloud such as for example, Amazon, Google, CenturyLink, or RackSpace to name a few, or it can reside at Enterprise A, Business B, or any combination of the aforementioned locations.

This Intelligent Third Party Edge Node can have connectors, including but not limited to APIs so that Enterprise A can utilize Business B's data or decision science and simultaneously not allow Business B to see Enterprise A's data and results for privacy purposes.

In some embodiments, there can be a number NE of Enterprises using the Intelligent Third Party Edge Node(s).

In some embodiments, there can be a number NE of Enterprises using immutable Intelligent Edge Node(s) and immutable Intelligent Third Party Edge Node(s).

In some embodiments, there can be a number NE of Enterprises and anonymous users using immutable Intelligent Edge Node(s) and immutable Intelligent Third Party Edge Node(s).

In some embodiments, there can be a number NE of anonymous users using immutable Intelligent Edge Node(s)

Additionally, an Enterprise can license and run the Intelligent Third Party Edge Node in their private network and behind their firewall. For example a car manufacturer or a pharmaceutical company may need to pull in massive data or decision science to help the company make R&D decisions, manufacturing decisions, product marketing decisions, and advertising decisions.

In some embodiments, the Intelligent Third Party Edge Node(s) have the ability to transmit and receive data or decision science, software updates, and data from an Intelligent Transceiver. These updates, for example, facilitate fast and automated data or decision science computations and software revisions to indexers, databases, immutable ledgers or blockchains (or both), graphs, algorithms, machine learning (ML), artificial intelligence (AI) software, or apps, or combinations thereof, as new information is available and released. In an example aspect, these iterative updates make the Intelligent Third Party Edge Node smarter and faster over time. An Intelligent Third Party Edge Node as disclosed herein can comprise any combination of the aforementioned features or embodiments.

Other Types of Intelligent Edge Nodes

Intelligent edge nodes may also include “Master Data” Edge Nodes, which can comprise Intelligent Master Database Management software and systems as well as immutable ledgers or blockchains (or both). Master Data edge nodes (e.g., one or more intelligent edge nodes storing master data) may generally refer to master databases and immutable ledgers or blockchains (or both) that contain reliable and trustworthy data, which can be relied on by other systems or devices for verification purposes. For example, a customer CRM system that contains information such as customer name, address, and billing information is a basic form of the single source of truth system. There can also be Application Specific Edge Nodes specialized to perform tasks for a particular application.

Intelligent Edge Nodes typically fall into two families: Parent edge nodes and Child edge nodes. A Parent edge node comprises a superset of Child edge node features and functionalities and is typically characterized as having more compute, store, and data or decision science capability relative to Child edge nodes. Tasks that Parent edge nodes can perform comprise: providing data or decision science driven (e.g. algo, ML, or AI-based) preemptive actions and recommendations to other Parent and Child edge nodes; responding to queries from other Parent and Child edge nodes including, but not limited to, user initiated data, decision science queries, as well as machine to machine initiated data or decision science based queries; performing data or decision science (e.g. algo, ML, AI, machine vision) on the master data stores and immutable ledgers; synthesizing data residing in the stores to identify, infer, and/or predict emerging consumer, business and technology related trends, correlations (for example, using the STRIPA methodology); receiving data from a number N_{PC} of Parent and Child edge nodes in order to fill in or complete missing master data, including but not limited to data store, metadata stores, graph data stores, immutable ledger, third-party systems, and other data science data stores; performing master data management functionality relative to other Parent and child edge nodes; transmitting master data to other Parent and Child edge nodes (Transceiver); performing the transceiver functionality by receiving data (listening and ingesting data over a number of channels, frequencies, wired and wireless networks, and other transmission channels) and by transmitting data, metadata, immutable records, and data or decision science to other Parent and Child edge nodes.

By contrast, child edge nodes may just have one or two of the aforementioned tasks, features, and/or functions.

Intelligent Edge Node Walkthrough and Processing Examples

In some embodiments, an Intelligent Edge Node can be inserted at a point where data is first created. An Intelligent XD Ecosystem as disclosed herein can comprise a number of different intelligent edge nodes inserted at points where data is first created, each generating machine data and metadata, user generated data and metadata, system data, immutable records and metadata. Additionally, each intelligent edge node can comprise data or decision science STRIPA intelligence, wherein intelligence includes but is not limited data or decision science that: can apply STRIPA filters and can ignore known known answers and data; can apply STRIPA to sense and detect certain types of data, patterns, immutable records, images, audio, multimedia, etc. and to update edge node(s) and/or notify users, and/or update third party systems; can apply STRIPA to reference, tag and/or index known known an or new anomaly or new unknowns; can apply STRIPA to the data and can take action(s) including but not limited applying automated or batch oriented business rules, applying automated or batch oriented apps, or performing system or workflow actions using data science and/or business rules; can apply STRIPA to the data and can take action(s) including but not limited to applying automated or batch oriented business rules, applying automated or batch oriented apps, performing system or workflow actions using algos and/or business rules based on a prioritizing algorithm or rules; can apply STRIPA to the data and can send alerts and messages to other edge node(s), synthesizer(s), and third party edge nodes to alert and fast track irregularities and/or new unknowns. In some embodiments, edge node(s) can have an Intelligent Transceiver to send, receive, and execute new data or decision science, software revisions, and data in real-time or batch orientations so that the edge node(s) have the latest information in order to take appropriate action(s). An Intelligent edge node as disclosed herein can comprise any combination of the aforementioned features or embodiments.

Intelligent Aggregation Edge Nodes, Networks, IoT devices, Components, and/or Systems

An Intelligent XD Ecosystem as disclosed herein can comprise a number of different Intelligent Edge Nodes inserted at points where data is first created, each generating machine data and metadata, user generated data and metadata, system data, immutable ledgers or blockchains (or both), immutable records, and metadata. Additionally, each Intelligent edge node can comprise data or decision science (e.g., STRIPA) intelligence. In some embodiments, progressively smarter and/or more powerful Intelligent Aggregation Edge Nodes, Networks, IoT devices, Components, and/or Systems, can be inserted downstream from an Intelligent Edge Node.

Additionally, each Intelligent edge node can comprise data or decision science (e.g., STRIPA) intelligence, wherein intelligence includes but is not limited data or decision science that: can apply STRIPA filters and can ignore known known answers and data; can apply STRIPA to sense and detect certain types of data, patterns, images, audio, multimedia, immutable ledgers or blockchains (or both), and immutable records, etc. and to update edge node(s) and/or notify users, and/or update third party systems; can apply STRIPA to reference, tag and/or index known known an or new anomaly or new unknowns; can apply STRIPA to the data and can take action(s) including but not limited applying automated or batch oriented business rules, applying automated or batch oriented apps, or performing system or workflow actions using algos and/or business rules; can apply STRIPA to the data and can take action(s) including but not limited to applying automated or batch oriented business rules, applying automated or batch oriented apps, performing system or workflow actions using algos and/or business rules based on a prioritizing algorithm or rules; or can apply STRIPA to the data and can send alerts and messages to other edge node(s), synthesizer(s), and third party edge nodes to alert and fast track irregularities and/or new unknowns; or a combination thereof. In some embodiments, edge node(s) can have an Intelligent Transceiver to send, receive, and execute new data or decision science, software revisions, and data in real-time or batch orientations so that the edge node(s) have the latest information in order to take appropriate action(s). An Intelligent Edge Node as disclosed herein can comprise any combination of the aforementioned features or embodiments.

The systems and related methods as disclosed above can result in many benefits, including for example: eliminating massive data collected, stored, indexed, analyzed, and STRIPA processing throughout customers/users big data analytic systems; accelerating surfacing answers by finding the critical, key, or important data—something akin to finding a “single needle on Mount Everest” data by eliminating most of the non-critical “Mount Everest” data at the point of data collection; accelerating making recommendations; and accelerating taking real-time actions.

The devices, systems and methods as disclosed herein can have the advantages of distributing decision making intelligence, computing, storing and corresponding autonomous actions as close to the point of where data is immediately captured. This consequently provides business and/or system(s) with recommendations and actions sooner and faster. Additionally, the system and method disclosed herein can enable intelligence to be real-time updated or “flashed” as new information is learned via transmitting and receiving new data or decision science to each edge node, synthesizer, and third party edge node(s). The system and method as disclosed herein can be employed to minimize and/or eliminate known knowns closest to the point of data capture thus freeing up network bandwidth and freeing up computing and storage capacity.

Intelligent Edge Node Industry Usage Walkthrough Example

In one example, an Intelligent Device is an IoT Device. The Intelligent IoT Device may be located or installed at one or more stages of a manufacturing process and can be configured to generate data and or immutable records by monitoring temperature, humidity, infrared light types, and the like. IoT devices without “intelligence” (also referred to herein as “unintelligent” IoT)—or an IoT device without the capability to perform any localized, onboard data science or decisions science algorithms—may be configured to continuously generate and send data, even if the subsequently generated data is exactly the same, a duplicate, or a “known known”. The “unintelligent” IoT device may send all of this data through networks and downstream computing systems, which in turn can determine if something is unusual about the temperature, humidity, or lighting conditions, or any other condition. Consequently, all duplicate XD may end up using bandwidth and compute resources.

In contrast, an Intelligent IoT Device, as disclosed herein, can have onboard compute and store analytics, such as filters, duplication algos and other analytics residing in ASICs, FPGAs, onboard RAM, or other components within the IoT device. As data or immutable records stream from an IoT sensor (e.g. an origin of data) to data or decision science components onboard the IoT device, the components can inspect data or immutable data in real-time, and “sniff” for data or immutable records that are nominal, a “known known”, or duplicative. If an evaluation of the data or immutable record results in a determination that the data is nominal, then the onboard processing units can purge, remove, or ignore the nominal XD or the “known known” XD. Alternatively, the onboard processing units can tag, mark and/or add a pointer to a data store or immutable ledger residing on the IoT device without having to store all the duplicate XD. Filtering and removing redundant XD remove the burden on other computing nodes and lowers network traffic.

If the IoT data or immutable record is “sniffed” by an onboard device with data or decision science components, and the data or immutable record has (or comprises) an anomaly, then the anomaly is sent or broadcasted through the existing network and edge node computing systems for analysis and/or can be marked with high priority for analysis. In some embodiments, the onboard compute can tag this data or immutable records with different priority levels or markers. Depending on the severity assigned to the anomaly, the intelligent IoT edge node can take action including but not limited to sending out an alert to users, systems, and apps. The intelligent IoT node can stop, modify, alter surrounding edge nodes, machines, systems, or take other actions in response to this anomaly based on business rules, workflows, technical responses, or other rules or conditions.

There are numerous manufacturing situations where IoT devices may be integrated yet are geographically disparate. When billions of IoT devices are generating real-time data or immutable records (example: human food processing QA tests and results, pharma mfg, precision mfg, etc.), there can be situations where certain geographic regions or locations result in detecting early anomalies sooner than other geographic disparate IoT devices. In these situations, Intelligent IoT nodes with onboard data or decision science can automatically message, alert, and recommend taking actions to other geographic disparate intelligent IoT devices.

### Intelligent IoT Device Step by Step Flow

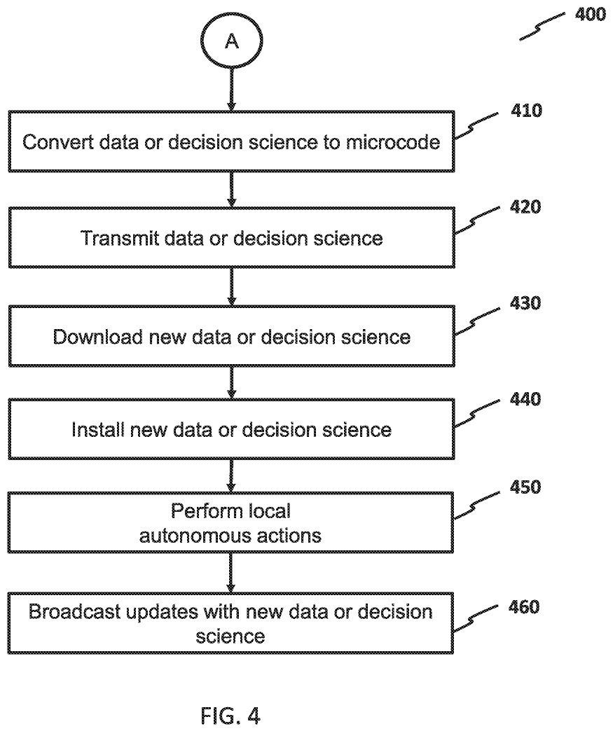

FIG. 4 shows a flowchart of a method 400 for updating an Intelligent Device according to an embodiment described herein. Intelligent Device data (e.g. data created or processed by an IoT device, or immutable record data) or decision science can be developed and converted to microcode at 410 (e.g. FPGA-based microcode or other microcode format that suits the processor type). The Intelligent IoT data or decision science can be transmitted at 420 over network(s) using an Intelligent Transceiver. An Intelligent IoT Transceiver(s) can listen for new data, meta data, immutable data (e.g., data from one or more edge nodes) or decision science and can be configured to download the new data or decision science at 430. An Intelligent IoT Transceiver can install or can “flash” the new data or decision science at 440 into an FPGA. Alternatively, the operation at 440 may involve updating the existing data or decision science on the FPGA. The Intelligent IoT device is then operationalized using the latest data or decision science. Such installation or update may be performed autonomously or may be configured to be performed at certain intervals or may be triggered by certain events.

The Intelligent IoT Device can perform local, autonomous actions at 450 based upon the data processed on the IoT device. The Intelligent Transceiver can broadcast updates at 460 to the Intelligent IoT Device with new data or decision science as new algos are released. While the example is relation to an FPGA, other types of processors could be used in an Intelligent IoT Device, either in addition or in the alternative.

The process descriptions or blocks in the flowcharts presented in FIGS. 1, 2A-2C, and 3-4 may be understood to represent modules, segments, or portions of code or logic, which include one or more executable instructions for implementing specific logical functions or steps in the associated process. Alternative implementations are included within the scope of the present invention in which functions may be executed out of order from the order shown or described herein, including substantially concurrently or in reverse order, depending on the functionality involved, as would be understood by those reasonable skilled in the art after having become familiar with the teachings of the present invention.

### Immutable Data in the Intelligent XD Ecosystem

Managing XD involves autonomous distributed data computing and distributing the data store. This combination intrinsically lends itself to immutable data storage and processing, which is compute intensive and involves distributed, anonymous and secured storage ledgers.

Devices 110, 112, and 120 in FIG. 1, for example, perform autonomous distributed and orchestrated computing in relation to immutable data. For example, this architecture is utilized to distribute ledger storage, which is also highly storage intensive.

Below are example computing aspects of Intelligent Devices which apply to immutable data, or other types of data that are not immutable (e.g. data that can change), or a combination thereof.

In an example process (e.g. process A), one or more Intelligent Devices are autonomously orchestrated and assigned to perform an assigned compute task.

In another example process (e.g. process B), one or more Intelligent Devices are autonomously orchestrated and assigned to perform a compute task and as more compute devices become available, these newly freed up Intelligent devices are autonomously orchestrated and incorporated into the existing compute task.

In an example aspect of process A or process B, or both, the one or more Intelligent Devices each orchestrate themselves, or collaboratively determine orchestrations and assignments of compute tasks. In an example in which the data is immutable data, the compute tasks include verification computations.

In an example aspect of process A or process B, or both, these processes incorporate data science in at least one of (i) before, (ii) during and (iii) after to optimize compute tasks. For example:

(a) apply data science (machine learning, STRIPA) to autonomously predict and determine how many compute devices should be used to optimize compute time, compute resources, and competing projects before the task has begun;
(b) apply data science (machine learning, STRIPA) during the compute process to autonomously sample, assess and reallocate WIP compute resources in order to meet a goal(s), objective(s), deadline(s), technical or operating requirement(s), business rule(s), or any combination of the aforementioned; and
(c) apply data science (machine learning, STRIPA) after the compute task is completed to autonomously optimize compute workloads for a given compute task while other competing compute tasks are processing so that the overall compute platform is optimized for overall throughput or enabling a high priority compute task is processed at the expense of other compute intensive tasks.

Other approaches to balancing loads of compute tasks can be applied herein.

Below are example storage aspects of Intelligent Devices which apply to immutable data, or other types of data that are not immutable (e.g. data that can change), or a combination thereof.

In an example process (e.g. process C), one or more storage devices (e.g. one or more Intelligent Devices) are autonomously orchestrated and assigned to at least one of capture, index, and store secured data. For example, the data forms part of, or forms the entirety of, or is used in relation to, a distributed ledger or a blockchain (or both).

In an example process (e.g. process D), one or more storage devices (e.g. one or more Intelligent Devices) are autonomously orchestrated and assigned to at least one of capture, index, and store secured data. For example, the data forms part of, or forms the entirety of, or is used in relation to, a distributed ledger or a blockchain (or both). In an example aspect of the system in which the data is ledge data, as the ledger data outgrows the originally assigned ledger devices, new ledger storage devices are autonomously summoned, orchestrated and incorporated in XD ledger environments.

In an example aspect of process C or process D, or both, the one or more Intelligent Devices each orchestrate themselves, or collaboratively determine orchestrations and assignments of one or more of capture, index, and store tasks.

In an example aspect, process C or process D, or both, incorporate data science in at least one of (i) before, (ii) during and (iii) after to optimize storage of the data, such in the form of a distributed ledger. For example:
a. apply data science (machine learning, STRIPA) to autonomously predict and determine how much secured storage ledger devices (e.g. which Intelligent Devices) and space should be initially summoned and reserved before storage is consumed;
b. apply data science (machine learning, STRIPA) during the compute process to autonomously sample, assess and reallocate work-in-progress storage in order to meet a goal(s), objective(s), deadline(s), technical or operating requirement(s), business rule(s), or any combination of the aforementioned;
c. apply data science (machine learning, STRIPA) after the storage task is completed in order to autonomously optimize secured ledger storage for future storage ledger tasks while concurrently competing with other WIP storage ledger tasks; and
d. apply data science (machine learning, STRIPA) in real time to autonomously socialize and agree which devices are trusted “master” ledger edge nodes (e.g. a type of Intelligent Device).

It is herein recognized that many immutable technologies, such as blockchain technologies and, more generally, distributed ledger technologies, use many devices to complete a computation (e.g. a verification computation, a transaction computations, a computation to add data to a ledger, a cryptocurrency distribution computation, an authentication computation, etc.). It also herein recognized that many of these computations are redundant amongst the multiple devices, and that devices in such ledger networks or blockchain networks are inefficiently utilized. Furthermore, having a large number of devices execute the same or similar computations is resource intensive (e.g. hardware, software and data transmission intensive).

Therefore, in an example aspect, the systems provided herein autonomously identify which ones of the edge nodes satisfy conditions to be trusted master ledger edge nodes. The trusted master ledger edge nodes are a subset (or are multiple subsets) of the entire available set of edge nodes. For example, the trusted master edge nodes have satisfied one or more of the following conditions: fast computations; timely computational results in response to requests or contextual need; have high uptime connectivity performance; have low communication latency; reliable in their computations; are secure (e.g. have little or no history of being hacked, or have history of defending against hacks, or both); consistently get the same answer a subject node gets (e.g. the same answer as a node belonging to a user); and consistently get the right answer. Therefore, in an example embodiment, a subject node (e.g. an Intelligent Device) communicates with the trusted master ledger nodes to execute compute tasks, instead of communicating with other ledger nodes.

In an example aspect, data science is applied amongst one or more Intelligent Devices to determine the appropriate number, N, of trusted master ledger nodes and their ledgers, as opposed to updating all ledgers on all devices. Using this approach materially reduces compute and store time by not updating every existing ledger in an immutable ecosystem and rather trusting N number of master edge ledgers on N trusted master ledger nodes.

Using the computing approaches described herein, data is stored redundantly, and Intelligent Devices that can be added to the Intelligent XD Ecosystem without any downtime. This reduces XD data, known known data, and compute and store resources.

In another example aspect, the collaboration of Intelligent devices facilitates incorporating data science before or during computing tasks or storing tasks, or both, for data work flow management purposes. For example, data science is applied to autonomously move ledger data from one storage device ledger to a different storage device ledger(s). This can be implemented according to: one device to many devices; many devices to many device; and many devices to one device.

These devices apply technical parameters, operational parameters, business rules, or any combination of the aforementioned to each ledger transaction(s) to autonomously move compute and or store data from one compute and or store ledger device to a different compute and or store ledger device.

The movement of data between devices occurs under various conditions. For example, one or more subject Intelligent Devices have “hot data” and needs to activate one or more ancillary storage devices since it running out of data storage room, and subsequently transfer the hot data to the one more ancillary storage devices. In another example, one or more subject Intelligent Devices has reached a threshold limit on its processing power (e.g. it is running out of processing power) and, in response, the one or more subject Intelligent Devices transmit data to one or more other Intelligent Devices to activate distributed processing on the one or more other Intelligent Devices. In another example, the conditions for one or more subject Intelligent Devices to move data or computations, or both, to one or more ancillary Intelligent Devices is tactical.

In an example tactical condition, the one or more subject Intelligent Devices are better suited for a first type of computations and executing a second type of computations is undesirable (e.g. inefficient to execute the second type of computations, slows down performance of executing the first type of computations, etc.). Therefore, the one or more subject Intelligent Devices collaborate with the one or more ancillary Intelligent Devices to assign the second type of computations to be executed by the one or more ancillary Intelligent Devices, which allows more resources of the one or more subject Intelligent Devices to be assigned to executed the first type of computations.

For example, the first type of computations are verifications, and the second type of computations are queries.

In another example, the Intelligent Devices dynamically determine which types of computations are categorized as the first type of computations for the subject Intelligent Devices, and which types of computations are categories as the second type of computations for the ancillary Intelligent Devices. In an example embodiment, ML and STRIPA are used to perform these dynamic determinations. It will be appreciated that these data and these computations are not limited to immutable data.

In another example aspect, the Intelligent Devices apply math, data science, technical rules, operational rules, business rules, or any combination of the aforementioned to each ledger transaction(s) and conduct one or more of the following computations:

encrypt with a different encryption method;
aggregate data, metadata, results, statistics, trends, recommendations, actions, resulting algos or and combination of the aforementioned and insert these results into a secured ledger(s) for faster recall in the future;
cache ledger transactions and items aforementioned that are constantly queried for faster recall in the future; and
execute, using data science, time-to-live (TTL) cached ledger transactions.

In an example aspect, TTL ledger transactions are stored in cache for a certain amount of time (e.g. as determined by TTL data science computations). For example, the data may persist in cache for only a certain amount of time before it is discarded. A non-limiting example of such data is ephemeral security data, or security data that is purposely deleted after some time amount has expired to improve security. In a further aspect, “hot data” is stored in cache or ram. Medium-term data is moved from cache or RAM to be stored in solid state memory devices. Longer-term data is moved from cache, RAM or solid state memory devices to spinning discs. Machine learning or STRIPA, or both, are used to dynamically determine whether data is classified as hot data, medium-term data, or longer-term data.

### Intelligent Edge Node, XD and Immutability Industry Usage Walkthrough Example: Food Processing and Manufacturing

It is herein recognized that the supply chain, manufacturing, and distribution of human consumed food and beverages requires faster, more transparent, and auditable records and reports in order to track, measure, and report when a food poisoning outbreak occurs. In a simplistic example, when a food or a drink has been confirmed for the possibility of causing food poisoning, an integrated and intelligent immutable based consumer application and enterprise ecosystem is provided that can quickly and reliably perform the following example features.

For example, the Intelligent XD ecosystem facilitates in real-time consumers to input their information in their computing device (e.g. an Intelligent Device). The inputted information relates to a specific food or beverage induced poisoning anonymously and securely via the Internet app. The process includes: a) capture personally identifiable information (PII) without disclosing to upstream users of data (autonomous or progressive PII disclosure); b) capturing the store or restaurant where food purchased or consumed; c) capturing the store or restaurant receipt; d) capturing a photograph showing one or more of the food barcode and human readable information, manufacturer, lot and bin number, and manufacturing and processing date; e) applying data science (e.g. ML and STRIPA) as more related consumer data points arrives to make recommendations based on the aggregate consumer collected data; and transmitting anonymized data, recommendations, meta data, and pictures to upstream sources (examples of which are listed below).

In a further operation, the Intelligent XD ecosystem facilitates real time notification of store(s) or restaurant(s) of the food induced poisoning. This notification can trigger one or more of the following operations, which can occur on other Intelligent Devices: a) finding and pulling food or beverage from shelves matching manufacturer lot and bin number and manufacturing and processing dates; b) performing quality assurance (QA) tests and reports to determine if food induced poisoning originated at this location(s); c) report results from QA tests; d) apply data science (ML and STRIPA) as more related consumer data arrives to make recommendations based on the aforementioned consumer data; e) transmit anonymized data, recommendations, meta data, and pictures to upstream sources (below); and f) take action including cleaning equipment, shelves, etc. and notifying employees of strict food handling rules, regulations, and procedures. Aspects of these operations can be fully automated or semi-automated.

In a further example operation, the Intelligent XD ecosystem facilitates real time notification of distributors of the food induced poisoning. This notification can trigger one or more of the following operations, which can occur on Intelligent Devices: a) find, pull, and remove food or beverage from warehouses and trucks matching manufacturer lot and bin number and manufacturing and processing dates; b) perform QA tests and report to determine if food induced poisoning originated at this location(s); c) report results from QA tests; d) apply data science (ML and STRIPA) as more related consumer data arrives to make recommendations based on the aforementioned consumer data; e) transmit anonymized data, recommendations, meta data, and pictures to upstream sources (below); and f) take action including cleaning equipment, shelves, etc. and notifying employees of strict food handling rules, regulations, and procedures. Aspects of these operations can be fully automated or semi-automated.

In a further example operation, the Intelligent XD ecosystem facilitates real time notification to manufacturer(s) and processor(s) of food or drink. This notification can trigger one or more of the following operations, which can occur on Intelligent Devices: a) find, pull, and remove food or beverage inventory at the plant matching manufacturer lot and bin number and manufacturing and processing dates; b) stop and clean all equipment related to food or beverage that manufactured and processed food or drink matching manufacturer lot and bin numbers; c) find, pull, and remove all raw materials and supplies at the plant matching manufacturer lot and bin number and manufacturing and processing dates; d) perform QA tests and report to determine if food induced poisoning originated at this location(s); e) report results from QA tests; f) apply data science (ML and STRIPA) as more related consumer data arrives to make recommendations based on the aforementioned consumer data; g) transmit anonymized data, recommendations, meta data, and pictures to upstream sources (below); and h) take action including cleaning equipment, shelves, etc. and notifying employees of strict food handling rules, regulations, and procedures. Aspects of these operations can be fully automated or semi-automated.

In a further example operation, the Intelligent XD ecosystem facilitates real time notification to raw material and suppliers. This notification can trigger one or more of the following operations, which can occur on Intelligent Devices: a) find, pull, and remove raw materials and supplies from warehouses and trucks matching manufacturer lot and bin number and manufacturing and processing dates; b) stop and clean all equipment related to raw materials and supplies that manufactured and processed food or drink matching manufacturer lot and bin numbers; c) perform QA tests and report to determine if food induced poisoning originated at this location(s); d) report results from QA tests; e) apply data science (ML and STRIPA) as more related consumer data arrives to make recommendations based on the aforementioned consumer data; f) transmit anonymized data, recommendations, meta data, and pictures to upstream sources (below); and g) take action including cleaning equipment, shelves, etc. and notifying employees of strict food handling rules, regulations, and procedures. Aspects of these operations can be fully automated or semi-automated.

In a further example operation, the Intelligent XD ecosystem facilitates real time notification to any other upstream raw material, suppliers, farms, ranches that grow, manufacture, and process raw materials, supplies and livestock. This notification can trigger one or more operations (similar to the above operations), which can occur on Intelligent Devices.

The Intelligent XD ecosystem, preferably in real time, autonomously updates the ecosystem ledgers as new information is discovered, as tests performed, and as data science based reports and recommendations become available. The devices in the Intelligent XD ecosystem transmits reports of the results from the initial start of the supply chain all the way to the consumer web portal where the consumers entered their information.

While pharmaceutical manufacturing and distribution has stricter rules and regulations, the principles and operations of the above example food and beverage approach (with appropriate modifications to be in FDA pharma compliance) can be applied to the pharmaceutical industry. These devices, systems and processes can also be used in the supply chain and processing systems of other types of human-consumables, such as supplements, cosmetics, surgical supplies, medical supplies, implantable objects like an organ or a stent or the like, prosthetics, dental hardware, contacts, etc.

In another example embodiment, an intelligent edge node device is provided that includes: memory that stores data science algorithms and local data that is first created directly or indirectly by the intelligent edge node device; one or more processors that are configured to at least perform localized decision science using the data science algorithms to process the local data; and a communication device. The communication device communicates with other intelligent edge node devices in relation to one or more of: the data science algorithms, the processing of the local data, and an anomalous result pertaining to the local data.

For example, the processing includes determining whether or not the local data is a known known, and discarding the local data from the memory after identifying that it is the known known.

In an example aspect, the one or more processors convert the local data to microcode and the communication device transmits the microcode to the other intelligent edge node devices.

In another example aspect, the one or more processors convert the one or more data science algorithms to microcode and the communication device transmits the microcode to the other intelligent edge node devices.

In another example aspect, the communication device receives microcode and the one or more processors perform local autonomous actions utilizing the microcode, wherein the microcode is at least one of new data and a new data science algorithm.

In another example aspect, the memory or the one or more processors, or both, are flashable with one or more new data science algorithms.

In another example aspect, the memory stores an immutable ledger that is distributed on the intelligent edge node device and the other intelligent edge node devices.

In another example aspect, the local data is biological-related data that is stored on the immutable ledger.

In another example aspect, the local data is manufacturing data that is stored on the immutable ledger.

In another example aspect, the intelligent edge node device is used in a processing system for human-consumables (e.g. food, drugs, supplements, cosmetics, surgical supplies, medical supplies, implantable objects like an organ or a stent or the like, prosthetics, dental hardware, contacts, etc.), and the local data pertains to a given human-consumable and the local data is stored on the immutable ledger.

In another example aspect, the intelligent edge node device is a satellite and the local data is satellite data that is stored on the immutable ledger. In an example aspect, the satellite data is sensed by one or more sensors on the satellite. In another example, the satellite data is communication data that has been received by the satellite, and the communication data is configured to be transmittable by a ground station or another satellite.

In another example aspect, the one or processors perform additional localized data science to autonomously predict how many of the other intelligent edge node devices are to be utilized to complete the determining of whether or not the local data is the known known, before computations for the determining have begun.

In another example aspect, the one or processors perform additional localized data science during performing the determining of whether or not the local data is the known known, the additional localized data science including autonomously sampling, assessing and reallocating work-in-progress compute resources amongst the other intelligent edge node devices.

In another example aspect, the intelligent edge node device is a brain-computer interface (e.g. which is a type of human-computer interface). In an alternative example aspect, the communication device of the intelligent edge node device receives data from and transmits data to a brain-computer interface. In particular, in the field of human-computer interfaces, it is recognized that brain signals, nerve signals, muscle signals, chemical signals, hormonal signals, etc. and other types of biological related data can be sensed by an intelligent edge node device and acted upon by the same intelligent edge node device, or some ancillary edge node device. Examples of intelligent edge node devices that interact with a brain-computer interface of a given user include a robotic drone, a robotic prosthetic limb, a computing device with voice chat capabilities, muscle stimulating devices, and other brain-computer interfaces of other users. The biological related data or other data utilized by these devices are, for example, stored on an immutable ledger that is distributed over multiple other intelligent edge node devices.

In another example aspect, the one or more processors include a neuromorphic chip.

In another example aspect, the intelligent edge node device further includes one or more sensors for collecting the local data and one or more actuators controllable by the one or more processors. The actuators are controllable in response to the processors processing the local data.

In another example aspect, the intelligent edge node device is part of an electric power production plant, and the local data pertains to operation and performance of the electric power production plant. In a further example aspect, this local data is stored on the immutable ledger. This helps to provide secure and reliable control and operation of an electric power production plant. Examples of electric power production plants include nuclear power plants, hydroelectric power plant, coal power plants, solar power plants, and wind power plants. In a further aspect, a system of intelligent edge node devices collaborate in the control and operation of the electric power plant. Examples of these devices include controllable valve actuators, transformers, cooling devices, fans, temperature sensors, electrical relay devices, radiation sensors, pressure sensors, camera devices, and current sensors.

In another example aspect, the intelligent edge node device is part of a water treatment plant, and the local data pertains to operation and performance of the water treatment plant, and the local data is stored on the immutable ledger. This helps to provide secure and reliable control and operation of the water treatment process. For example, cities or municipalities have an extensive infrastructure network for water treatment. Water treatment herein includes one or more of the following operations: obtaining water for drinking, treating water for drinking, distributing the water for drinking, receiving waste water, treating the waste water, and releasing or dumping the treated waste water. In a further aspect, a system of intelligent edge node devices collaborate in the control and operation of the water treatment plant. Examples of these devices include controllable valve actuators, pump devices, flow sensors, pressure sensors, chemical sensors, chemical dispenser devices, electrical relay devices, camera devices, and electrical current sensors.

It will be appreciated that any device, module or component exemplified herein that executes instructions may include or otherwise have access to computer readable media such as storage media, computer storage media, or data storage devices (removable and/or non-removable) such as, for example, solid state memory, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the Intelligent Devices or accessible or connectable thereto. Any application or module herein described may be implemented using computer readable/executable instructions that may be stored or otherwise held by such computer readable media.

It will be appreciated that different features of the example embodiments of the devices, system and methods, as described herein, may be combined with each other in different ways. In other words, different devices, modules, operations, functionality and components may be used together according to other example embodiments, although not specifically stated.

The steps or operations in the flow diagrams described herein are just for example. There may be many variations to these steps or operations according to the principles described herein. For instance, the steps may be performed in a differing order, or steps may be added, deleted, or modified.

It will also be appreciated that the examples and corresponding system diagrams used herein are for illustrative purposes only. Different configurations and terminology can be used without departing from the principles expressed herein. For instance, components and modules can be added, deleted, modified, or arranged with differing connections without departing from these principles.

Although the above has been described with reference to certain specific embodiments, various modifications thereof will be apparent to those skilled in the art without departing from the scope of the claims appended hereto.

1. A system for managing vast amounts of data to provide distributed and autonomous decision based actions, comprising:
a plurality of intelligent edge nodes, wherein at least one of the plurality of intelligent edge nodes is inserted at a point where local data is first created and wherein the at least one of the plurality of intelligent edge nodes is configured to perform localized decision science related to the local data;
a plurality of intelligent networks for transmitting data to and from the at least one of the plurality of intelligent edge nodes, wherein at least one of the plurality of intelligent networks has embedded intelligence and wherein the transmitted data is based at least in part on the local data; and
a plurality of intelligent message buses interconnected with the at least one of the plurality of intelligent edge nodes and the at least one of the intelligent networks, wherein at least one of the plurality of intelligent message buses are configured to perform autonomous actions based at least on the transmitted data.

2. The system of claim 1, wherein the at least one of the plurality of intelligent edge nodes is configured to create local data and to execute the localized decision science to evaluate the local data.

3. The system of claim 1, wherein the at least one of the plurality of intelligent networks has the ability to communicate with other intelligent networks, make autonomous network decisions, and/or take autonomous network actions.

4. The system of claim 2, wherein the evaluation of the local data comprises making a determination as to whether the local data is known known or an anomaly.

5. The system of claim 4, wherein the at least one of the plurality of intelligent edge nodes is configured to discard the local data if the local data is determined to be known known.

6. The system of claim 4, wherein the at least one of the plurality of intelligent edge nodes is configured to update a local and/or global data store, data science, graph database, immutable ledgers and records, or third party system with the local data based at least on determining whether data is a known known or unknown.

7. The system of claim 4, wherein the at least one of the plurality of intelligent edge nodes is configured to update data science across one or more data stores, applications, immutable ledgers, systems, and third-party systems.

8. The system of claim 4, wherein the at least one of the plurality of intelligent edge nodes is configured to query one or more non-local systems to evaluate data from other non-local systems, wherein the evaluate comprises determining whether the data is known or unknown, and wherein the non-local systems comprise data store, data science, immutable ledgers, graph database, index, memory, or application.

9. The system of claim 4, wherein the at least one of the plurality of intelligent edge nodes is configured to update tags or references for the local data to existing local data stored locally and/or to other global Intelligent edge nodes, data stores, immutable ledgers, applications, systems, and third-party systems based at least on determining whether the local data is a known known or unknown.

10. The system of claim 4, wherein the at least one of the plurality of intelligent edge nodes is configured to send a message related to the local data via the at least one of the intelligent message buses based at least on determining whether the local data is a known known or an unknown.

11. The system of claim 10, wherein the at least one of the plurality of intelligent edge nodes is configured to autonomously send the message and/or take actions related to the local data via the at least one of the plurality of intelligent message buses.

12. The system of claim 4, wherein the at least one of the plurality of intelligent edge nodes is configured to make an autonomous decision or to take an autonomous action in response to the evaluation of data comprising one or more of the local data, and/or data transmitted from other data stores, applications, immutable ledgers, systems and third-party systems.

13. The system of claim 12, wherein the evaluation of the local data and/or data transmitted from other data stores, applications, systems and third-party system is determined in response to an application selected from the group consisting of business rules, data science, computing requirements, and workflow actions applied to the local data.

14. The system of claim 4, wherein the at least one of the plurality of intelligent edge nodes is configured to autonomously update a local data store, data science, graph database, application, immutable ledgers, index, and memory to include the local data if the local data is determined to be an anomaly.

15. The system of claim 4, wherein the at least one of the plurality of intelligent edge nodes is configured to autonomously update the one or more non-local systems to include the local data if the local data is determined to be an anomaly, wherein the non-local systems comprise data store, data science, graph database, immutable ledgers, index, memory, or app.

16. The system of claim 2, wherein the evaluation of the local data comprises automatically communicating and querying each of the plurality of intelligent edge nodes and/or one or more data stores, applications, data science, immutable ledgers, systems, and third-party systems to determine if the local data is a known known or an anomaly.

17. The system of claim 15, wherein the at least one of the plurality of intelligent edge nodes is configured to update a local data store, data science, graph database, immutable ledgers, index, memory, or app, to include the local data if the query results from each of the plurality of Intelligent edge nodes comprise no answers.

18. The system of claim 15, wherein the at least one of the plurality of intelligent edge nodes is configured to autonomously send a message related to the local data and or one or more data stores, data science systems, applications, immutable ledgers, and third-party systems through at least one of the plurality of intelligent networks if the query results from each of the plurality of intelligent edge nodes comprise no answers.

19. The system of claim 15, wherein at least one of the plurality of intelligent edge nodes is configured to autonomously update a local data store, data science, immutable ledgers, graph database, index, memory, or app, to include the local data and or non-local data store, applications, systems, and third-party systems, and optionally to take a corresponding autonomous decisions and/or autonomous action if the query results from at least another one of the plurality of Intelligent edge nodes responds with answers indicating the data is known or unknown.

20. The system of claim 19, wherein the corresponding action is in response to an evaluation of the local data and/or one or more non-local data stores, applications, immutable ledgers, systems, and third-party systems.

21. The system of claim 20, wherein the evaluation of the local data is determined in response to an application selected from the group consisting of business rules, data science, computing requirements, and workflow actions applied to the local data and/or non-local data stores, applications, systems, immutable ledgers, and third-party systems.

22. The system of claim 20 wherein the plurality of intelligent edge nodes are part of a manufacturing system.

23. The system of claim 20 wherein the plurality of intelligent edge nodes are part of a processing system for human-consumable products.

24. The system of claim 20 wherein the plurality of intelligent edge nodes include a brain-computer interface and one or more devices that communicate with the brain-computer interface.

25-42. (canceled)
